(19) United States
(12) Patent Application Publication
(10) Pub. No.: US 2015/0259577 A1
(43) Pub. Date: Sep. 17, 2015

(54) FLUORINE-CONTAINED RUBBER COMPOSITION AND SEAL MEMBER

(71) Applicant: JTEKT CORPORATION, Osaka (JP)

(72) Inventor: Toshiyuki BABA, Kashihara-shi (JP)

(21) Appl. No.: 14/636,775

(22) Filed: Mar. 3, 2015

(30) Foreign Application Priority Data
Mar. 13, 2014 (JP) 2014-050313

(51) Int. Cl. C09J 115/02; C08K 3/04

(52) U.S. Cl. CPC C09J 115/02; C08K 3/04; C08K 2003/045

(57) ABSTRACT

A fluorine-contained rubber composition is compounded of a fluorine-contained rubber, large-particle-diameter carbon black having a particle diameter of 90 nanometers or more, and carbon black for coloring having a particle diameter of 30 nanometers or less. A seal member is produced by forming the fluorine-contained rubber composition into a certain form and by vulcanizing the resulting fluorine-contained rubber composition. Selected drawing: None

### INCORPORATION BY REFERENCE

The disclosure of Japanese Patent Application No. 2014-050313 filed on Mar. 13, 2014 including the specification, drawings, and abstract is incorporated herein by reference in its entirety.

### BACKGROUND OF THE INVENTION

1. Field of the Invention

The invention relates to a fluorine-contained rubber composition that is suitable as a material for forming seal members such as oil seals and a seal member formed by using the fluorine-contained rubber composition.

2. Description of Related Art

As a material for forming seal members such as oil seals, a fluorine-contained rubber is preferably used that can form a vulcanizate excellent in heat resistance, oil resistance, and chemical resistance, for example (see Japanese Patent Application Publication No. 2008-138017 (JP 2008-138017A) , for example). A reinforcing effect of the fluorine-contained rubber due to carbon black serving as a reinforcing material is about two times greater than reinforcing effects of other rubbers, and thus the compounding ratio of the carbon black can be reduced. However, from the opposite view point, excessively compounding the carbon black for reinforcement makes the vulcanizate excessively hard, thereby deteriorating rubber elasticity. In view of this, it can be said that the compounding ratio of the carbon black is limited.

The fluorine-contained rubber is more expensive than other rubbers. Accordingly, when cost reduction of seal members, for example, is considered, it is desired to reduce the ratio of the fluorine-contained rubber as low as possible by compounding a large amount of carbon black or other components as extenders. In view of this, it is common that large-particle-diameter carbon black having a particle diameter of 90 nanometers or more and having a relatively small reinforcing effect is compounded as a reinforcing material serving as an extender, as large amount as possible within a range in which the hardness of the vulcanizate can be prevented from increasing and the rubber elasticity can be maintained.

However, because interaction between particles of such large-particle-diameter carbon black is weak and the carbon black easily falls off from the vulcanizate, abrasion resistance of the vulcanizate problematically deteriorates particularly when the carbon black is compounded in a large amount. To prevent this deterioration of abrasion resistance, further compounding solid lubricant such as polytetrafluoroethylene (PTFE) and graphite has been studied. However, the solid lubricant generally has a low affinity for the fluorine-contained rubber and easily becomes a starting point of fracture. Thus, when the solid lubricant is compounded, a new issue arises that tensile strength of the vulcanizate deteriorates.

### SUMMARY OF THE INVENTION

It is an object of the present invention to provide a fluorine-contained rubber composition that can form a vulcanizate excellent in abrasion resistance, with a minimum ratio of a fluorine-contained rubber that can prevent the hardness of the vulcanizate from increasing to maintain rubber elasticity, and even without compounding solid lubricant that reduces the tensile strength, and to provide a seal member made of the vulcanizate of the fluorine-contained rubber composition.

According to an aspect of the present invention, a fluorine-contained rubber includes large-particle-diameter carbon black having a particle diameter of 90 nanometers or more and carbon black for coloring having a particle diameter of 30 nanometers or less.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a graph illustrating results of DIN abrasion tests and hardness tests of Examples 1 to 4 of the present invention, Comparative Example 1, and Related-art Example 1; and

FIG. 2 is a graph illustrating results of DIN abrasion tests and hardness tests of Examples 1 and 5 of the present invention and Related-art Example 1.

### DETAILED DESCRIPTION OF EMBODIMENTS

A fluorine-contained rubber composition of the present invention contains a fluorine-contained rubber, large-particle-diameter carbon black having a particle diameter of 90 nanometers or more, and carbon black for coloring having a particle diameter of 30 nanometers or less. As the fluorine-contained rubber, one or two types or more of various polymers are used that have fluorine in molecules, are vulcanizable, and also exhibit rubber elasticity when being vulcanized. Examples of the fluorine-contained rubber include vinylidene-fluoride-based (FKM) polymers such as a vinylidene fluoride-chlorotrifluoroethylene binary copolymer, a vinylidene fluoride-hexafluoropropylene binary copolymer, and a vinylidene fluoride-hexafluoropropylene-tetrafluoroethylene ternary copolymer; tetrafluoroethylene-propylene-based (FEPM) polymers; and tetrafluoroethylene-perfluorovinylether-based (FFKM) polymers.

The fluorine-contained rubbers are classified according to their types of vulcanization into a polyol-vulcanizing system, a peroxide-vulcanizing system, an isocyanate-vulcanizing system, and a polyamine-vulcanizing system, for example, and any of these can be used. Some of the fluorine-contained rubbers already contain a curing agent when supplied, and such a curing-agent-containing type can be used. Among these, in particular, a vinylidene-fluoride-based fluorine-contained rubber of the polyol-vulcanizing system and also the curing-agent-containing type is suitably used because it can form a vulcanizate that is excellent in versatility and handleability and also excellent in rubber elasticity, abrasion resistance, and tensile strength, for example.

The particle diameter of the large-particle-diameter carbon black is limited to 90 nanometers or more. This is because carbon black for reinforcement having a particle diameter smaller than this range has a great reinforcing effect, and accordingly the total compounding ratio of carbon black that can prevent the hardness of the vulcanizate from increasing to maintain rubber elasticity is limited, so that the effect of relatively reducing the ratio of the fluorine-contained rubber cannot be obtained.

In consideration of suppressing the reinforcing effect to further prevent the hardness of the vulcanizate from increasing, the particle diameter of the large-particle-diameter carbon black is preferred to be larger even within the range, and is preferably 100 nanometers or more, and particularly preferably 120 nanometers or more. However, even within the range, the particle diameter of the large-particle-diameter carbon black is preferably 150 nanometers or less, and particularly preferably 130 nanometers or less.

Large-particle-diameter carbon black having a particle diameter over this range cannot obtain sufficient interaction between particles even when being used with carbon black for coloring, so that the large-particle-diameter carbon black may easily fall off from the vulcanizate, leading to reduction in abrasion resistance. The dibutyl phthalate (DBP) oil absorption of the large-particle-diameter carbon black is preferably 20 ml/100 g or more, and particularly preferably 40 ml/100 g or more. This DBP oil absorption is also preferably 70 ml/100 g or less, and particularly preferably 45 ml/100 g or less.

Large-particle-diameter carbon black the DBP oil absorption of which is smaller than this range is difficult to be evenly dispersed in the fluorine-contained rubber. This difficulty may cause imbalances in the distribution of the carbon black, thereby causing unevenness in strength or hardness, for example, of the vulcanizate. Large-particle-diameter carbon black the DBP oil absorption of which is larger than the range has a greater reinforcing effect. This greater reinforcing effect may limit the total compounding ratio of the carbon black for preventing the hardness of the vulcanizate from increasing to maintain the rubber elasticity, so that the ratio of the fluorine-contained rubber may be unable to be relatively reduced.

In contrast, by using large-particle-diameter carbon black the DBP oil absorption of which satisfies the range described previously, the large-particle-diameter carbon black can be dispersed in the fluorine-contained rubber as evenly as possible, whereby a vulcanizate whose strength and hardness, for example, are even can be formed. Even when the compounding ratio is further increased, the hardness of the vulcanizate can be prevented from increasing to maintain preferable rubber elasticity, and thus the ratio of the fluorine-contained rubber can be further relatively reduced.

The compounding ratio of the large-particle-diameter carbon black is preferably 20 parts by mass or more, and particularly preferably 25 parts by mass or more per 100 parts by mass of the fluorine-contained rubber. This compounding ratio is also preferably 40 parts by mass or less, and particularly preferably 35 parts by mass or less.

When the compounding ratio is lower than this range, the reinforcing effect of compounding the large-particle-diameter carbon black cannot be sufficiently obtained, so that the abrasion resistance or the tensile strength, for example, of the vulcanizate may deteriorate.

When the compounding ratio exceeds the range described previously, the excessively compounded large-particle-diameter carbon black is likely to fall off from the vulcanizate, and accordingly the abrasion resistance may deteriorate. Furthermore, the vulcanizate may become so hard that the rubber elasticity is lost. When a fluorine-contained rubber of the curing-agent-containing type described previously is used as the fluorine-contained rubber being the reference for the compounding ratio, the compounding ratio of the large-particle-diameter carbon black needs to be set within the range described previously on the assumption that the total amount of the fluorine-contained rubber including the contained curing agent is 100 parts by mass. This applies to a vulcanization accelerator, an acid acceptor, and a processing aid, for example, described later.

The particle diameter of the carbon black for coloring is limited to 30 nanometers or less. This is because carbon black for coloring having a particle diameter over this range has a great reinforcing effect, and accordingly the total compounding ratio of carbon black that can prevent the hardness of the vulcanizate from increasing to maintain rubber elasticity is limited, so that the effect of relatively reducing the ratio of the fluorine-contained rubber cannot be obtained.

This is also because the interaction becomes weak, so that the effect of improving the abrasion resistance of the vulcanizate by increasing the interaction between particles of the large-particle-diameter carbon black to prevent the carbon black from falling off cannot be obtained. To further improve these effects, even within the range, the particle diameter of the carbon black for coloring is preferably 26 nanometers or less. The lower limit of the particle diameter of the carbon black for coloring is not limited to a particular value. Any of various carbon blacks for coloring can be used ranging to a carbon black that is available for coloring having a minimum particle diameter, specifically ranging to a particle diameter of about 10 nanometers.

However, smaller particle diameter of the carbon black for coloring tends to make the reinforcing effect stronger, thereby increasing the hardness of the vulcanizate. To prevent the hardness from increasing, even within the range, the particle diameter of the carbon black for coloring is preferably 15 nanometers or more, and particularly preferably 18 nanometers or more.

The DBP oil absorption of the carbon black for coloring is preferably 40 ml/100 g or more, and particularly preferably 50 ml/100 g or more. This DBP oil absorption is also preferably 120 ml/100 g or less.

Carbon black for coloring the DBP oil absorption of which is smaller than this range is difficult to be evenly dispersed in the fluorine-contained rubber. This difficulty may cause imbalances in the distribution of the carbon black, thereby causing unevenness of the effect of strengthening the interaction of the large-particle-diameter carbon black in the vulcanizate. Consequently, the large-particle-diameter carbon black cannot be partially prevented from falling off from the vulcanizate, so that the abrasion resistance of the vulcanizate may deteriorate.

Carbon black for coloring the DBP oil absorption of which is larger than the range has a greater reinforcing effect. This greater reinforcing effect may limit the total compounding ratio of the carbon black for preventing the hardness of the vulcanizate from increasing to maintain the rubber elasticity, so that the ratio of the fluorine-contained rubber may be unable to be relatively reduced. In contrast, it is easy to evenly disperse the carbon black for coloring the DBP oil absorption of which satisfies the range described previously in the fluorine-contained rubber. The interaction of the large-particle-diameter carbon black can be evenly strengthened in the vulcanizate to prevent partial falling off. Thus, the abrasion resistance of the vulcanizate can be improved, and also the ratio of the fluorine-contained rubber can be relatively reduced by increasing the compounding ratio because the reinforcing effect is small.

The compounding ratio of the carbon black for coloring is preferably 3 parts by mass or more, further preferably 5 parts by mass or more, and particularly preferably 8 parts by mass or more per 100 parts by mass of the large-particle-diameter carbon black. This compounding ratio is also preferably 20 parts by mass or less, further preferably 15 parts by mass or less, and particularly preferably 12 parts by mass or less. When the compounding ratio is lower than this range, the effect of improving the abrasion resistance of the vulcanizate by using the carbon black for coloring in combination to increase the interaction between particles of the large-particle-diameter carbon black and prevent the carbon black from falling off may be unable to be sufficiently obtained.

When the compounding ratio exceeds the range, the vulcanizate becomes so hard that the rubber elasticity may be lost. In the fluorine-contained rubber composition of the present invention, a vulcanization accelerator, an acid acceptor, and a processing aid, for example, may be compounded in the same manner as conventionally done.

Among these, as the vulcanization accelerator, calcium hydroxide is suitably used for the fluorine-contained rubber of a polyol-vulcanizing system, for example. The compounding ratio of the calcium hydroxide is preferably 3 parts by mass or more, and is preferably 10 parts by mass or less per 100 parts by mass of the fluorine-contained rubber. Examples of the acid acceptor include magnesium oxide and lead oxide (litharge).

The compounding ratio of the acid acceptor is preferably 1 part by mass or more, and is preferably 5 parts by mass or less per 100 parts by mass of the fluorine-contained rubber. Examples of the processing aid include various waxes. In particular, a variety of grades of carnauba waxes are preferred. The compounding ratio of the processing aid is preferably 0.5 part by mass or more, and is preferably 5 parts by mass or less per 100 parts by mass of the fluorine-contained rubber.

Examples of the seal member of the present invention include a variety of oil seals, packings, O rings, and gaskets. These seal members are produced by forming the fluorine-contained rubber composition obtained by compounding the components previously described at certain ratios, into a certain form by any faulting methods such as injection molding, extrusion molding, and press molding, and then by vulcanizing the resulting fluorine-contained rubber composition.

### Example 1

In 100 parts by mass of a vinylidene-fluoride-based fluorine-contained rubber of a polyol-vulcanizing system and also a curing-agent-containing type [Dyneon (registered trademark) FE5641Q manufactured by Sumitomo 3M Ltd., binary copolymer, fluorine content: 65.9%], the components given in Table 1 below were compounded, and were kneaded to prepare a fluorine-contained rubber composition.

TABLE 1

| Component | Parts by mass |
|---|---|
| Large-particle-diameter carbon black | 30 |
| Carbon black for coloring | 3 |
| Vulcanization accelerator | 6 |
| Acid acceptor | 3 |
| Processing aid | 1 |

The following describes the respective components in Table 1. Large-particle-diameter carbon black: Asahi #15 manufactured by Asahi Carbon Co.,

Ltd. [mean particle diameter: 122 nanometers, DBP oil absorption (A method): 41 ml/100 g]

Carbon black for coloring: Sun Black (registered trademark) SB300 manufactured by Asahi Carbon Co., Ltd. [mean particle diameter: 18 nanometers, DBP oil absorption (A method): 119 ml/100 g]

Vulcanization accelerator: calcium hydroxide, CALDIC #2000 manufactured by Ohmi Chemical Industry Co., Ltd.

Acid acceptor: magnesium oxide, Kyowamag (registered trademark) 150 manufactured by Kyowa Chemical Industry Co., Ltd.

Processing aid: purified carnauba wax No. 1 powder

Subsequently, the fluorine-contained rubber composition prepared was formed in a sheet shape having a thickness of six millimeters or more, and was primarily vulcanized by heating at 170° C. for 10 minutes. Subsequently, the resulting sheet was secondarily vulcanized by heating at 230° C. for 10 hours, and was then cut in a disk shape having a diameter of 16.0 ±0.2 millimeters to produce a specimen for the DIN abrasion test specified in Japan Industrial Standards JIS K6264-2: 2005 “Rubber, vulcanized or thermoplastic-Determination of abrasion resistance-Part 2: Testing methods”.

### Example 2

A fluorine-contained rubber composition was prepared to produce a specimen in the same manner as in Example 1 except that Sun Black SB720 [mean particle diameter: 20 nanometers, DBP oil absorption (A method): 56 ml/100 g] manufactured by Asahi Carbon Co., Ltd. was compounded in the same amount as the carbon black for coloring.

### Example 3

A fluorine-contained rubber composition was prepared to produce a specimen in the same manner as in Example 1 except that Sun Black SB200 [mean particle diameter: 26 nanometers, DBP oil absorption (A method): 100 ml/100 g] manufactured by Asahi Carbon Co., Ltd. was compounded in the same amount as the carbon black for coloring.

### Example 4

A fluorine-contained rubber composition was prepared to produce a specimen in the same manner as in Example 1 except that Sun Black SB910 [mean particle diameter: 14 nanometers, DBP oil absorption (A method): 55 ml/100 g] manufactured by Asahi Carbon Co., Ltd. was compounded in the same amount as the carbon black for coloring.

### Comparative Example 1

A fluorine-contained rubber composition was prepared to produce a specimen in the same manner as in Example 1 except that Sun Black SB260 [mean particle diameter: 45 nanometers, DBP oil absorption (A method): 114 ml/100 g] manufactured by Asahi Carbon Co., Ltd. was compounded in the same amount as the carbon black for coloring.

### Related-Art Example 1

A fluorine-contained rubber composition was prepared to produce a specimen in the same manner as in Example 1 except that carbon black for coloring was not compounded and the compounding ratio of the large-particle-diameter carbon black was 35 parts by mass.

### DIN Abrasion Test

On each of the specimens produced in Examples 1 to 4, Comparative Example 1, and Related-art Example 1, the DIN abrasion test specified in the JIS K6264-2: 2005 was conducted to evaluate the abrasion resistance.

The test conditions were as follows: abrasive cloth (alumina grain size P60), pressing load (7.5 N), roll rotation speed (40 min⁻¹), and abrasion distance (40 meters).

### Hardness Test

On each of the specimens produced in Examples 1 to 4, Comparative Example 1, and Related-art Example 1, the type A durometer hardness was measured. Hardness differences from the hardness of Related-art Example 1 serving as a reference (±0) were determined to evaluate hardness changes.

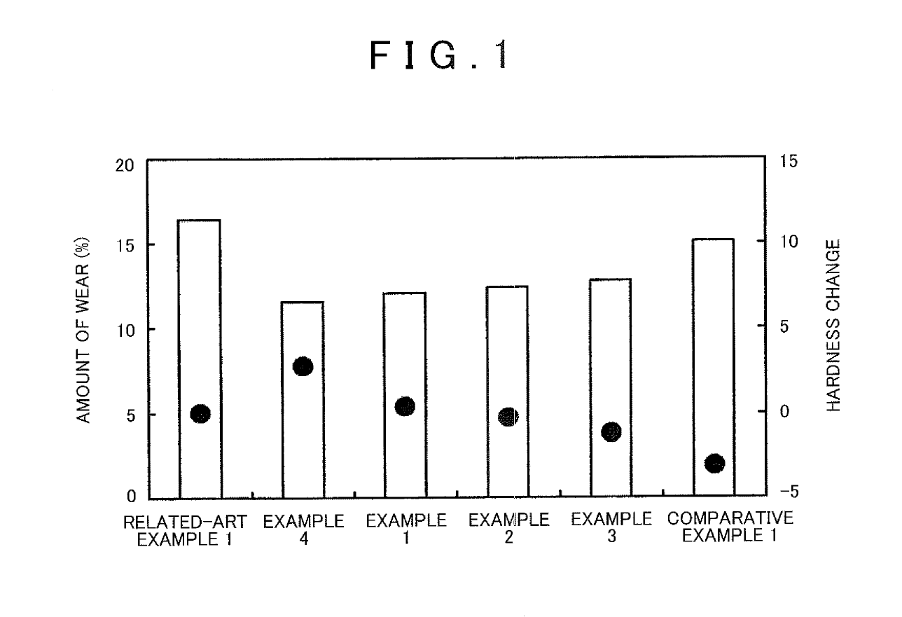

The results are given in FIG. 1.

It was found from FIG. 1 that the amount of wear was large and the abrasion resistance was insufficient in both of Comparative Example 1 in which large-particle-diameter carbon black having a particle diameter of 90 nanometers or more and carbon black for coloring having a particle diameter over 30 nanometers are compounded and Related-art Example 1 in which carbon black for coloring was not compounded.

In contrast, it was found that the abrasion resistance was excellent in all of Examples 1 to 4 in which large-particle-diameter carbon black having a particle diameter of 90 nanometers or more and carbon black for coloring having a particle diameter of 30 nanometers or less are used in combination because the amounts of wear were smaller than those of Comparative Example 1 and Related-art Example 1.

It was also found from the results of Examples 1 to 4 that the particle diameter of the carbon black for coloring was preferably 15 nanometers or more, and particularly preferably 18 nanometers or more even within the range equal to or smaller than 30 nanometers in order to prevent the hardness of the vulcanizate from increasing.

### Example 5

A fluorine-contained rubber composition was prepared to produce a specimen in the same manner as in Example 1 except that Asahi #51 [mean particle diameter: 91 nanometers, DBP oil absorption (A method): 67 ml/100 g] manufactured by Asahi Carbon Co., Ltd. was compounded in the same amount as the large-particle-diameter carbon black.

### Comparative Example 2

A fluorine-contained rubber composition was tried to be prepared to produce a specimen in the same manner as in Example 1 except that Asahi #50 [mean particle diameter: 80 nanometers, DBP oil absorption (A method): 63 ml/100 g] manufactured by Asahi Carbon Co., Ltd. was compounded in the same amount as the large-particle-diameter carbon black. However, preparation of the specimen and the DIN abrasion test were abandoned because the vulcanized sheet became so hard that the rubber elasticity was lost.

The DIN abrasion test was conducted on the specimen produced in Example 5 to evaluate the abrasion resistance. The hardness test was also conducted to evaluate the hardness change.

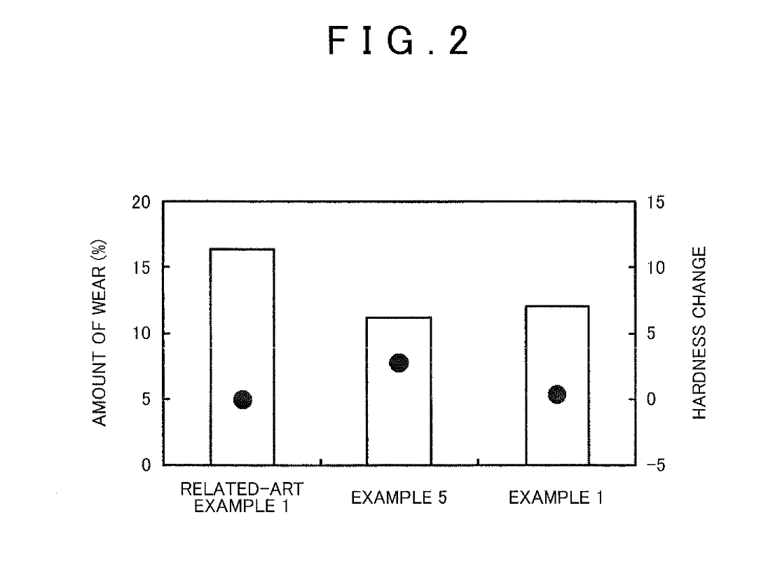

The results are given with the results of Example 1 and Related-art Example 1 in FIG. 2.

It was found from FIG. 2 that the particle diameter of the large-particle-diameter carbon black needs to be 90 nanometers or more, and is preferably 100 nanometers or more, particularly preferably 120 nanometers or more in order to prevent the hardness of the vulcanizate from increasing and maintain the rubber elasticity.

What is claimed is:

1. A fluorine-contained rubber composition comprising:
a fluorine-contained rubber;
large-particle-diameter carbon black having a particle diameter of 90 nanometers or more; and
carbon black for coloring having a particle diameter of 30 nanometers or less.

2. The fluorine-contained rubber composition according to claim 1, wherein
a DBP oil absorption of the large-particle-diameter carbon black is 20 ml/100 g or more and 70 ml/100 g or less.

3. The fluorine-contained rubber composition according to claim 1, wherein
a DBP oil absorption of the carbon black for coloring is 40 ml/100 g or more and 120 ml/100 g or less.

4. The fluorine-contained rubber composition according to claim 2, wherein
a DBP oil absorption of the carbon black for coloring is 40 ml/100 g or more and 120 ml/100 g or less.

5. A seal member comprising:
a vulcanizate of the fluorine-contained rubber composition as claimed in claim 1.

6. A seal member comprising:
a vulcanizate of the fluorine-contained rubber composition as claimed in claim 2.

7. A seal member comprising:
a vulcanizate of the fluorine-contained rubber composition as claimed in claim 3.

8. A seal member comprising:
a vulcanizate of the fluorine-contained rubber composition as claimed in claim 4.
